(19) United States
(12) Patent Application Publication
(10) Pub. No.: US 2010/0004112 A1
(43) Pub. Date: Jan. 7, 2010

(54) OPTICAL GLASS

(75) Inventors: Hiroyuki OHKAWA, Tokyo (JP); Naoki Sugimoto, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Asahi Glass Company, Limited, Tokyo (JP)

(21) Appl. No.: 12/557,943

(22) Filed: Sep. 11, 2009

Related U.S. Application Data
(63) Continuation of application No. PCT/JP08/54538, filed on Mar. 12, 2008.

(30) Foreign Application Priority Data
Mar. 14, 2007 (JP) 2007-065189

(51) Int. Cl. C03C 3/253; C03C 3/21

(52) U.S. Cl. 501/42; 501/46

(57) ABSTRACT

An object of the present invention is to provide an optical glass having optical constants of a refractive index of 1.70 to 1.89 and an Abbe number of 20 to 30 and being excellent in chemical durability. The invention relates to an optical glass containing P₂O₅: 10 to 30, Nb₂O₅: 25 to 50, B₂O₃: 0.1 to 30, BaO: 0.1 to 2, Li₂O: 0 to 10, Na₂O: 0.1 to 4, K₂O: 0 to 10, Bi₂O₃: 1 to 20, GeO₂: 0 to 14, TiO₂: 0.1 to 5, and WO₃: 1 to 14, in terms of % by mass.

### TECHNICAL FIELD

The present invention relates to a phosphate optical glass applicable to precise press-molding, particularly being excellent in mechanical properties.

### BACKGROUND ART

Hitherto, as an optical glass having a high dispersibility, there is a phosphate optical glass containing P₂O₅ as a fundamental component, but there is a problem that the mechanical properties thereof are insufficient and, during the production steps such as polishing and washing of an optical glass element or during its use over a long period of time, a scratch is easily given on the surface and a crack resulting from the scratch is apt to be generated. Thus, there has been desired to develop a phosphate optical glass excellent in handling properties during the production or in durability of a product.

In the case where an optical glass element is produced by a precise press-molding method wherein the optical surface is merely subjected to press-molding without post-processing, an optical glass containing alkali metal/alkaline earth metal elements is adopted in order to facilitate the molding. Therefore, particularly, the issue of mechanical properties becomes important.

In order to improve the moldability of the phosphate optical glass, compositions containing a large amount of alkali metal element(s) have been proposed in Patent Documents 1 and 2, but they are not satisfactory in respect of mechanical properties.

Patent Document 1: JP-A-2005-154248 (Detailed Description of the Invention, etc.)

Patent Document 2: JP-A-2003-160355 (Detailed Description of the Invention, etc.)

### DISCLOSURE OF THE INVENTION

### Problems that the Invention is to Solve

An object of the invention is to provide a phosphate-based optical glass having optical constants of a refractive index of 1.70<n_{d}<1.89 and an Abbe number of 20 to 30 and also being excellent in mechanical properties.

### Means for Solving the Problems

The invention provides an optical glass comprising P₂O₅: 10 to 30, Nb₂O₅: 25 to 50, B₂O₃: 0.1 to 30, BaO: 0.1 to 2, Li₂O: 0 to 10, Na₂O: 0.1 to 4, K₂O: 0 to 10, Bi₂O₃: 1 to 20, GeO₂: 0 to 14, TiO₂: 0.1 to 5, and WO₃: 1 to 14, in terms of % by mass. The invention further provides an optical glass comprising P₂O₅: 10 to 30, Nb₂O₅: 30 to 50, B₂O₃: 0.1 to 30, BaO: 0.1 to 2, Li₂O: 0 to 10, Na₂O: 0.1 to 4, K₂O: 0 to 10, Bi₂O₃: 1 to 20, GeO₂: 0 to 14, TiO₂: 0.1 to 5, and WO₃: 1 to 14, in terms of % by mass.

It is preferred that the optical glass of the invention substantially comprises P₂O₅: 10 to 30, Nb₂O₅: 25 to 50, B₂O₃: 0.1 to 30, BaO: 0.1 to 2, Li₂O: 0 to 10, Na₂O: 0.1 to 4, K₂O: 0 to 10, Bi₂O₃: 1 to 20, GeO₂: 0 to 14, TiO₂: 0.1 to 5, and WO₃: 1 to 14, in terms of % by mass. It is further preferred that the optical glass of the invention substantially comprises P₂O₅: 10 to 30, Nb₂O₅: 30 to 50, B₂O₃: 0.1 to 30, BaO: 0.1 to 2, Li₂O: 0 to 10, Na₂O: 0.1 to 4, K₂O: 0 to 10, Bi₂O₃: 1 to 20, GeO₂: 0 to 14, TiO₂: 0.1 to 5, and WO₃: 1 to 14, in terms of % by mass.

### ADVANTAGE OF THE INVENTION

The phosphate-based optical glass of the invention (hereinafter referred to as present glass) contains P₂O₅, Nb₂O₅, B₂O₃, BaO, Na₂O, Bi₂O₃, TiO₂, and WO₃ as essential components and hence has optical properties of a high refractive index and a high dispersibility. According to the present glass, optical properties of a refractive index n_{d} of 1.70 to 1.89 and an Abbe number ν_{d} of 20 to 30 are obtained.

According to the present glass, since the liquidus temperature (L.T.) can be made 900° C. or lower, the optical glass is hardly devitrified and the productivity is improved. Moreover, according to the present glass, since the glass transition temperature (T_{g}) can be made 525° C. or lower, the degree of deterioration of a protective film and a release film usually formed on a mold surface is reduced and, as a result, the durability of the mold is improved, thereby remarkably improving the productivity.

Furthermore, according to the present glass, since mechanical properties such as Vickers hardness are excellent, handling property during the production steps of an optical element is excellent, and also a scratch or the like is hardly given during the use of the optical element, so that the durability of the optical element is improved.

### BEST MODE FOR CARRYING OUT THE INVENTION

The present glass comprises individual components of P₂O₅, Nb₂O₅, B₂O₃, BaO, Na₂O, Bi₂O₃, TiO₂, and WO₃. The reasons for setting the ranges of the individual components are as follows. In the present description, % means % by mass hereinafter unless otherwise noted.

In the present glass, P₂O₅ is a main component which forms the glass (glass-forming oxide) and is an essential component. In the present glass, when the content of P₂O₅ is too small, there is a concern that the glass may become unstable, e.g., the glass may become easily devitrified. Therefore, the content of P₂O₅ is 10% or more in the present glass. The content of P₂O₅ is preferably 15% or more and the content of P₂O₅ is more preferably 20% or more. The content of P₂O₅ is particularly preferably 23% or more.

On the other hand, when the content of P₂O₅ increases, it becomes difficult to obtain desired optical properties and also a molding temperature becomes high. Therefore, the content of P₂O₅ is 30% or less in the present glass. The content of P₂O₅ is preferably 29% or less and the content of P₂O₅ is more preferably 28% or less. The content of P₂O₅ is particularly preferably 26% or less.

In the present glass, Nb₂O₅ is an essential component for obtaining desired optical properties. When the content of Nb₂O₅ is too small, there is a concern that desired optical properties may be not obtained. Therefore, the content of Nb₂O₅ in the present glass is 25% or more. The content of Nb₂O₅ is preferably 28% or more and the content of Nb₂O₅ is more preferably 29% or more. The content of Nb₂O₅ is particularly preferably 30% or more.

On the other hand, when the content of Nb₂O₅ increases, it becomes difficult to obtain desired optical properties and also the glass becomes unstable. Therefore, the content of Nb₂O₅ in the present glass is 50% or less. The content of Nb₂O₅ is preferably 45% or less and the content of Nb₂O₅ is more preferably 40% or less. The content of Nb₂O₅ is particularly preferably 36% or less.

In the present glass, B₂O₃ is an essential component and has an effect of stabilizing the glass. When the content of B₂O₃ is too small, there is a concern that the above effect may become insufficient. Therefore, the content of B₂O₃ in the present glass is 0.1% or more. The content of B₂O₃ is preferably 0.5% or more and the content of B₂O₃ is more preferably 0.7% or more. The content of B₂O₃ is particularly preferably 4% or more.

On the other hand, when the content of B₂O₃ increases, it becomes difficult to obtain desired optical properties and also the molding temperature becomes high. Therefore, the content of B₂O₃ in the present glass is 30% or less. The content of B₂O₃ is preferably 10% or less and the content of B₂O₃ is more preferably 80% or less. The content of B₂O₃ is particularly preferably 6% or less.

In the present glass, BaO is an essential component and has an effect of stabilizing the glass. When the content of BaO is too small, there is a concern that the above effect may become insufficient. Therefore, the content of BaO in the present glass is 0.1% or more. The content of BaO is preferably 0.2% or more and the content of BaO is more preferably 0.5% or more. The content of BaO is particularly preferably 0.7% or more.

On the other hand, when the content of BaO increases, it becomes difficult to obtain desired optical properties. Therefore, the content of BaO in the present glass is 2% or less. The content of BaO is preferably 1.5% or less and the content of BaO is more preferably 1.4% or less. The content of BaO is particularly preferably 1.3% or less.

In the present glass, Li₂O is not an essential component but has an effect of softening the glass. In the case where it is contained, the content of Li₂O is preferably 3% or more and the content of Li₂O is more preferably 4% or more, for easily obtaining the effect of softening the glass. The content of Li₂O is particularly preferably 4.5% or more.

On the other hand, when the content of Li₂O increases, there is a concern that the glass may become unstable. Therefore, the content of Li₂O is preferably 10% or less and the content of Li₂O is more preferably 7% or less. The content of Li₂O is particularly preferably 6% or less.

In the present glass, Na₂O is an essential component and has an effect of softening the glass. When the content is too small, there is a concern that the above effect may become insufficient. Therefore, the content of Na₂O in the present glass is 0.1% or more. The content of Na₂O is preferably 0.3% or more and the content of Na₂O is more preferably 0.5% or more. The content of Na₂O is particularly preferably 1.0% or more.

On the other hand, when the content of Na₂O increases, it becomes difficult to obtain desired optical properties and also there is a concern that the glass may become instable. Therefore, the content of Na₂O is 4% or less. The content of Na₂O is preferably 2.5% or less and the content of Na₂O is more preferably 2% or less. The content of Na₂O is particularly preferably 1.9% or less.

In the present glass, K₂O is not an essential component but has an effect of softening the glass. In the case where it is contained, the content of K₂O is preferably 1% or more and the content of K₂O is more preferably 3% or more, for easily obtaining the effect of softening the glass. The content of K₂O is particularly preferably 4% or more.

On the other hand, when the content of K₂O increases, it becomes difficult to obtain desired optical properties and also there is a concern that the glass may become unstable. Therefore, the content of K₂O is preferably 10% or less. The content of K₂O is more preferably 7% or less. The content of K₂O is particularly preferably 5% or less.

In the present glass, Bi₂O₃ is an essential component and has effects of softening the glass and also achieving a high refractive index and a high dispersibility. When the content is too small, there is a concern that the above effects may become insufficient. Therefore, the content of Bi₂O₃ in the present glass is 1% or more. The content of Bi₂O₃ is preferably 10% or more and the content of Bi₂O₃ is more preferably 12% or more. The content of Bi₂O₃ is particularly preferably 14% or more.

On the other hand, when the content of Bi₂O₃ increases, it becomes difficult to obtain desired optical properties and also the transmittance of visible light decreases. Therefore, the content of Bi₂O₃ is 20% or less. The content of Bi₂O₃ is preferably 19% or less and the content of Bi₂O₃ is more preferably 18% or less. The content of Bi₂O₃ is particularly preferably 17% or less. For the same reasons, the content of Bi₂O₃ in the present glass is most preferably 6% by mol or less.

In the present glass, GeO₂ is not an essential component but has an effect of stabilizing the glass. When the content is too small, there is a concern that the above effect may become insufficient. Therefore, the content of GeO₂ in the present glass is preferably 0.1% or more in the case where it is added. The content of GeO₂ is more preferably 1% or more. The content of GeO₂ is particularly preferably 2% or more.

On the other hand, when the content of GeO₂ increases, it becomes difficult to obtain desired optical properties and also the material cost increases. Therefore, the content of GeO₂ in the present glass is preferably 14% or less in the case where it is added, and the content of GeO₂ is more preferably 10% or less. The content of GeO₂ is particularly preferably 5% or less.

In the present glass, TiO₂ is an essential component and has an effect of achieving a high refractive index and a high dispersibility. When the content is too small, there is a concern that the above effect may become insufficient. Therefore, the content of TiO₂ in the present glass is 0.1% or more in the case where it is added. The content of TiO₂ is preferably 1% or more and the content of TiO₂ is more preferably 1.5% or more. The content of TiO₂ is particularly preferably 2% or more.

On the other hand, when the content increases, it becomes difficult to obtain desired optical properties and also the transmittance of visible light decreases. Therefore, the content is 5% or less. The content of TiO₂ is preferably 4% or less and the content of TiO₂ is more preferably 3.5% or less. The content of TiO₂ is particularly preferably 3% or less.

In the present glass, WO₃ is an essential component and has an effect of achieving a high refractive index and a high dispersibility. When the content is too small, there is a concern that the above effect may become insufficient. Therefore, the content of WO₃ in the present glass is 1% or more in the case where it is added. The content of WO₃ is preferably 4% or more and the content of WO₃ is more preferably 5% or more. The content of WO₃ is particularly preferably 6% or more.

On the other hand, when the content increases, the glass becomes unstable and also the transmittance of visible light decreases. Therefore, the content of WO₃ is 14% o or less. The content of WO₃ is preferably 12% or less and the content of WO₃ is more preferably 11% or less. The content of WO₃ is particularly preferably 10% or less.

In the present glass, in order to adjust the optical properties, any one or more of ZrO₂, Gd₂O₃, Ta₂O₅, La₂O₃, Y₂O₃, Yb₂O₃ or Ga₂O₃ can be added as optional component(s) When the content is small, the adjusting effect of the optical properties is hardly obtained. Therefore, the content is preferably 1% or more, in terms of the total amount of ZrO₂+Gd₂O₃+Ta₂O₅+La₂O₃+Y₂O₃+Yb₂O₃+Ga₂O₃ or in terms of the content of any one of ZrO₂, Gd₂O₃, Ta₂O₅, La₂O₃, Y₂O₃, Yb₂O₃ and Ga₂O₃. The above content is more preferably 2% or more and the above content is particularly preferably 3% or more.

On the other hand, since each of the above components for adjusting the optical properties is expensive, in the case where importance is attached to the cost, it is preferred to suppress the content as far as possible. Therefore, the content in the case where they are added is preferably 10% or less, more preferably 5% or less, particularly preferably 4% or less, in terms of the total amount of ZrO₂+Gd₂O₃+Ta₂O₅+La₂O₃+Y₂O₃+Yb₂O₃+Ga₂O₃ or in terms of the content of any one of ZrO₂, Gd₂O₃, Ta₂O₅, La₂O₃, Y₂O₃, Yb₂O₃ and Ga₂O₃.

Moreover, in the present glass, it is preferred from the viewpoint of molding temperature and the influence on the environmental aspects that SiO₂, ZnO, PbO, TeO₂, F and As₂O₃ are substantially not included. Herein, the substantially no inclusion means that the content is 0.05% or less.

In the present glass, Sb₂O₃ is not an essential component but can be added as a refining agent at the time of glass melting. The content thereof is preferably 1% or less, more preferably 0.5% or less, and particularly preferably 0.1% or less. In the present glass, the lower limit in the case where it is added is preferably 0.01% or more, more preferably 0.05% or more, and particularly preferably 0.1% or more.

As optical properties of the present glass, the refractive index n_{d} is preferably 1.70 to 1.89. The refractive index n_{d} is more preferably 1.80 or more and the refractive index n_{d} is particularly preferably 1.81 or more. Moreover, the refractive index n_{d} is more preferably 1.87 or less and the refractive index n_{d} is particularly preferably 1.86 or less.

The Abbe number ν_{d} of the present glass is preferably 20 to 30. The Abbe number ν_{d} is more preferably 21 or more and the Abbe number ν_{d} is particularly preferably 22 or more. Moreover, the Abbe number ν_{d} is more preferably 25 or less and the Abbe number ν_{d} is particularly preferably 24 or less.

When the liquidus temperature (L.T.) of the glass is 900° C. or lower, the glass becomes; hardly devitrified and the productivity is improved, which liquidus temperature is hence preferred. The liquidus temperature L.T. is more preferably 895° C. or lower and the liquidus temperature L.T. is particularly preferably 890° C. or lower. When the glass transition temperature T_{g} of the present glass is 525° C. or lower, the molding temperature can be lowered, and the durability of the protective film and the like formed on the mold surface is improved, which glass transition temperature is hence preferred. The glass transition temperature is more preferably 500° C. or lower and the glass transition temperature is particularly preferably 480° C. or lower.

As for a mechanical property of the present glass, when Vickers hardness Hv is 475 MPa or more, a scratch is hardly given on a product and handling at the production and durability at the use are improved, which Vickers hardness is hence preferred. The Vickers hardness Hv is more preferably 500 MPa or more. The Vickers hardness Hv is particularly preferably 525 MPa or more.

The method for producing the present glass is not particularly limited and, for example, it can be produced by weighing and mixing raw materials for use in a common optical glass, such as oxides, hydroxides, carbonates, and nitrates, placing the resultant mixture in a platinum crucible, melting, refining and stirring it at about 900 to 1100° C. for 2 to 10 hours, casting it into a mold that has been pre-heated to about 500° C., and gradually cooling the resultant product.

### EXAMPLES

Examples of the invention, etc. will be illustrated below. Examples 1 and 2 are Comparative Examples of the invention and Examples 3 to 15 are Working Examples of the invention. In this connection, Examples 1 and 2 are the Examples 5 and 7 described in JP-A-2005-154248, respectively.

### [Chemical Composition/Method of Sample Preparation]

Raw materials were weighed so as to form chemical compositions (%) shown in Tables 1 and 2. As the raw materials for each glass, H₃PO₄ was used in the case of P₂O₅, H₃BO₃ in the case of B₂O₃, BaCO₃ in the case of BaO, Li₂CO₃ in the case of Li₂O, Na₂CO₃ in the case of Na₂O, K₂CO₃ in the case of K₂O, respective oxides in the case of Nb₂O₅, Bi₂O₃, GeO₂, TiO₂, and WO₃. The weighed raw materials were mixed, the resultant mixture was placed in a platinum crucible having an inner volume of about 300 cc, melted at 900 to 1100° C. for 2 to 6 hours, refined, stirred, then cast into a rectangular mold having a size of length 150 mm×width 50 mm pre-heated at about 500° C., and subsequently gradually cooled at a rate of about 1° C./minute to form a sample.

### [Evaluation Method]

The refractive index n_{d} was a refractive index with respect to helium d line, and the Abbe number ν_{d} was determined from the equation: ν_{d}=(n_{d}−1)/(n_{F}−n_{c}), wherein n_{F} and n_{C} are a refractive index with respect to hydrogen F line and a refractive index with respect to hydrogen C line, respectively. In this connection, the refractive index was measured by a refractometer (manufactured by Kalnew Optical Industries, trade name: KRP-2). The measured value was determined up to five decimal place 3, the refractive index n_{d} was shown after rounded off to four decimal places, and the Abbe number ν_{d} was shown after rounded off to one decimal place.

The Vickers hardness Hv was evaluated by an indentation test method using a Vickers hardness-measuring machine (manufactured by AKASHI, trade name: MVK-12). Specifically, a Vickers indenter is indented to a smooth sample surface under an indentation load of 25 g and an indentation time of 15 seconds at room temperature under an air atmosphere and the Vickers hardness was determined based on the size of an indentation generated by the indenter indentation according to the following equation. Measurement was carried out five times for one sample and the Vickers hardness was determined from the average of three values excluding the maximum value and the minimum value.

Vickers hardness Hv (MPa)=(1.854 P/d²)×9.8

P: test load (kg)

d: diagonal length of indentation (mm)

With regard to the liquidus temperature, about 5 to 10 g of a glass sample was placed in a platinum dish and the sample kept at 870, 880, 890, 900, 910, or 920° C. for one hour was cooled under spontaneous cooling and then the presence of crystal precipitation was observed, the lowest temperature where no crystals were observed being regarded as the liquidus temperature.

The glass transition temperature T_{g} was measured at a temperature-elevating rate of 5° C./minute by the thermal expansion method by means of a thermometric apparatus (manufactured by Bruker AXS K.K., trade name: TMA4000SA).

With regard to the glass dissolution and the like, as a result of visual observation at the above sample preparation, it was confirmed that Examples 1 to 15 had no problem in dissolution and the resultant glass sample contained no bubbles and striae.

TABLE 1

| | Example 1 | Example 2 | Example 3 |
|---|---|---|---|
| P₂O₅ | 21.8 | 20.3 | 23.8 |
| B₂O₃ | 1.9 | 1.8 | 1.5 |
| GeO₂ | 0.0 | 0.0 | 3.1 |
| BaO | 1.0 | 0.0 | 1.1 |
| Li₂O | 4.0 | 2.9 | 4.8 |
| Na₂O | 4.5 | 6.0 | 1.4 |
| K₂O | 1.3 | 2.4 | 4.1 |
| Bi₂O₃ | 15.6 | 18.1 | 14.3 |
| TiO₂ | 2.7 | 2.6 | 2.3 |
| Nb₂O₅ | 33.7 | 32.8 | 35.0 |
| WO₃ | 12.4 | 12.0 | 8.6 |
| ZnO | 1.1 | 1.1 | 0.0 |
| Hᵥ/MPa | 459 | 466 | 514 |
| Refractive index n_{d} | 1.8794 | 1.8792 | 1.8519 |
| Abbe number ν_{d} | 22.0 | 21.8 | 23.1 |
| L.T./° C. | 920 | 930 | 890 |
| T_{g}/° C. | 453 | 445 | 477 |

TABLE 2

| | Example 4 | Example 5 | Example 6 |
|---|---|---|---|
| P₂O₅ | 24.9 | 24.9 | 24.5 |
| B₂O₃ | 1.6 | 1.6 | 1.6 |
| GeO₂ | 0.0 | 0.0 | 0.0 |
| BaO | 1.2 | 1.1 | 1.2 |
| Li₂O | 5.0 | 4.8 | 5.1 |
| Na₂O | 1.5 | 1.4 | 1.5 |
| K₂O | 4.3 | 4.2 | 4.4 |
| Bi₂O₃ | 15.0 | 16.8 | 15.3 |
| TiO₂ | 2.4 | 2.3 | 2.5 |
| Nb₂O₅ | 35.3 | 34.2 | 34.7 |
| WO₃ | 9.0 | 8.7 | 9.2 |
| ZnO | 0.0 | 0.0 | 0.0 |
| Hᵥ/MPa | 511 | 509 | 495 |
| Refractive index n_{d} | 1.8511 | 1.8536 | 1.8515 |
| Abbe number ν_{d} | 23.0 | 22.9 | 22.9 |
| L.T./° C. | 900 | 900 | 890 |
| T_{g}/° C. | 472 | 472 | 468 |

TABLE 3

| | Example 7 | Example 8 | Example 9 |
|---|---|---|---|
| P₂O₅ | 24.1 | 25.4 | 25.7 |
| B₂O₃ | 1.6 | 1.6 | 1.6 |
| GeO₂ | 0.0 | 0.0 | 0.0 |
| BaO | 1.2 | 1.1 | 1.1 |
| Li₂O | 5.2 | 4.8 | 4.9 |
| Na₂O | 1.5 | 1.4 | 1.4 |
| K₂O | 4.5 | 4.1 | 4.2 |
| Bi₂O₃ | 15.6 | 17.6 | 16.3 |
| TiO₂ | 2.5 | 2.8 | 2.9 |
| Nb₂O₅ | 34.4 | 32.6 | 33.1 |
| WO₃ | 9.4 | 8.6 | 8.7 |
| ZnO | 0.0 | 0.0 | 0.0 |
| Hᵥ/MPa | 490 | 517 | 513 |
| Refractive index n_{d} | 1.8525 | 1.8504 | 1.8470 |
| Abbe number ν_{d} | 23.0 | 23.0 | 23.1 |
| L.T./° C. | 900 | 890 | 900 |
| T_{g}/° C. | 464 | 470 | 472 |

TABLE 4

| | Example 10 | Example 11 | Example 12 |
|---|---|---|---|
| P₂O₅ | 26.2 | 26.4 | 26.4 |
| B₂O₃ | 4.8 | 4.8 | 4.8 |
| GeO₂ | 0.0 | 0.0 | 0.0 |
| BaO | 0.8 | 0.3 | 0.3 |
| Li₂O | 4.5 | 4.8 | 5.0 |
| Na₂O | 1.9 | 1.5 | 1.3 |
| K₂O | 3.7 | 3.6 | 3.6 |
| Bi₂O₃ | 15.1 | 15.2 | 15.3 |
| TiO₂ | 3.0 | 2.9 | 2.9 |
| Nb₂O₅ | 30.6 | 30.9 | 30.9 |
| WO₃ | 9.5 | 9.5 | 9.6 |
| ZnO | 0.0 | 0.0 | 0.0 |
| Hᵥ/MPa | 548 | 532 | 542 |
| Refractive index n_{d} | 1.8212 | 1.8220 | 1.8233 |
| Abbe number ν_{d} | 24.1 | 24.1 | 24.1 |
| L.T./° C. | 870 | 860 | 860 |
| T_{g}/° C. | 464 | 470 | 466 |

TABLE 5

| | Example 13 | Example 14 | Example 15 |
|---|---|---|---|
| P₂O₅ | 26.4 | 26.6 | 26.4 |
| B₂O₃ | 4.9 | 4.9 | 5.2 |
| GeO₂ | 0.0 | 0.0 | 0.0 |
| BaO | 0.3 | 0.3 | 0.1 |
| Li₂O | 5.1 | 5.1 | 4.5 |
| Na₂O | 1.1 | 0.5 | 1.8 |
| K₂O | 3.6 | 3.6 | 3.7 |
| Bi₂O₃ | 15.3 | 15.4 | 15.1 |
| TiO₂ | 2.9 | 2.9 | 3.0 |
| Nb₂O₅ | 30.9 | 31.1 | 30.7 |
| WO₃ | 9.6 | 9.6 | 9.5 |
| ZnO | 0.0 | 0.0 | 0.0 |
| Hᵥ/MPa | 539 | 535 | 558 |
| Refractive index n_{d} | 1.8237 | 1.8281 | 1.8197 |
| Abbe number ν_{d} | 24.1 | 23.9 | 24.0 |
| L.T./° C. | 860 | 870 | 860 |
| T_{g}/° C. | 468 | 470 | 469 |

While the invention has been described in detail and with reference to specific embodiments thereof, it will be apparent to one skilled in the art that various changes and modifications can be made therein without departing from the spirit and scope thereof.

The present application is based on Japanese Patent Application No. 2007-065189 filed on Mar. 14, 2007, and the contents thereof are incorporated herein by reference.

### INDUSTRIAL APPLICABILITY

Since the present substrate is a low-dispersible optical glass having a refractive index of a desired value and is excellent in mechanical properties and also excellent in press-molding ability, the substrate is useful as an optical glass for precise press-molding.

1. An optical glass comprising:
P₂O₅: 10 to 30,
Nb₂O₅: 25 to 50,
B₂O₃: 0.1 to 30,
BaO: 0.1 to 2,
Li₂O: 0 to 10,
Na₂O: 0.1 to 4,
K₂O: 0 to 10,
Bi₂O₃: 1 to 20,
GeO₂: 0 to 14,
TiO₂: 0.1 to 5, and
WO₃: 1 to 14,
in terms of % by mass.

2. The optical glass according to claim 1, wherein the content of Nb₂O₅ is 30 to 50% by mass.

3. The optical glass according to claim 1, which contains substantially no SiO₂, ZnO, PbO, TeO₂, F and As₂O₃.

4. The optical glass according to claim 1, having a refractive index n_{d} of 1.70 to 1.89 and an Abbe number ν_{d} of 20 to 30.

5. The optical glass according to claim 1, wherein a liquidus temperature (L.T.) is 900° C. or lower.

6. The optical glass according to claim 1, having a glass transition temperature (T_{g}) of 525° C. or lower.
